(19) United States
(12) Patent Application Publication
(10) Pub. No.: US 2006/0135197 A1
(43) Pub. Date: Jun. 22, 2006

(54) Apparatus and method for originating call using latest communication records in mobile communication terminal

(75) Inventors: Jeong-Gyu Jin, Suwon-si (KR); Doo-Hong Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/270,170

(22) Filed: Nov. 9, 2005

(30) Foreign Application Priority Data
Nov. 15, 2004 (KR) 10-2004-0093267

(51) Int. Cl. H04M 1/00

(52) U.S. Cl. 455/550.1; 455/414.1

(57) ABSTRACT

Disclosed are an apparatus and a method for originating a call using the latest communication records in a mobile communication terminal. The apparatus and the method include enabling a user to originate a call with a desired type of a phone number based on the latest communication records provided. The apparatus and the method displays at least one phone number which corresponds to a name, on a latest communication record image displayed on a display unit of a mobile communication terminal. The phone number can be displayed as an icon and may be classified into an office phone number, a home phone number, a cellular phone number, etc. The apparatus and the method further provide for the display of different phone number types for a selected recipient for communication on a latest communication record image and enable selective call origination based on the latest communication records when the mobile communication terminal originates a call.

### PRIORITY

This application claims priority to an application entitled “Apparatus and Method for Originating Call Using Latest Communication Records in Mobile Communication Terminal” filed in the Korean Intellectual Property Office on Nov. 15, 2004 and assigned Ser. No. 2004-93267, the contents of which are incorporated herein by reference.

### BACKGROUND OF THE INVENTION

1. Field of the Invention

The present invention relates to an apparatus and a method for originating a call in a mobile communication terminal, and more particularly to an apparatus and a method for originating a call in a mobile communication terminal which can easily originate the call based on call history information according to call information indicating whether a call was an incoming or outgoing call without an additional search for phone numbers.

2. Description of the Related Art

Mobile communication terminals, such as cellular phones, Personal Communication System (PCS) terminals, International Mobile Telecommunications (IMT)-2000 phones, and personal digital assistants (PDAs), can be carried by a user, and include a variety of convenience functions in addition to a voice communication function. The convenience functions include a call history recording function, a message transmitting and/or receiving function, a wireless Internet function, an alarm function, and a phone directory managing function.

The phone directory managing function may be realized by installing software for managing personal information in the mobile communication terminal. The phone directory managing function is selected using a menu selection, etc. More specifically, after executing the phone directory managing function, a user can input, edit, and store information relating to individual phone numbers. Additionally, the user can obtain desired data by reading the stored information after executing the phone directory managing function.

For example, after executing the phone directory managing function, the user may input phone numbers classified into an office phone number, a home phone number, a cellular phone number, etc. with respect to a name of a called party with which a communication was established. Accordingly, when several phone numbers are stored with respect to a name of a party with which a communication was established, icons matching with specific characters of the phone numbers are displayed in order to distinguish the phone numbers.

The call history recording function provides a user with call connection start time, time spent for communication (i.e., call duration), and the history of calls received in the user's absence (i.e., missed calls). This call history information may be displayed as a latest communication record as shown in FIG. 1.

A screen shot illustrating an example of a conventional list of latest communications, is shown in FIG. 1. Icons, including an icon 100 representing an outgoing (i.e., an originated) call, an icon 110 representing an incoming (i.e., a received) call, and an icon representing a call received in the user's absence (i.e., a missed call), distinguished according to communication characteristics, are displayed on the image showing call history information (i.e., a latest communication record image). In other words, the image displays icons according to communication characteristics, such as an icon corresponding to an automatic response in addition to the icon 100 corresponding to a called phone number, the icon 110 corresponding to an incoming call, and the icon representing the call received in the user's absence.

Simultaneously, the mobile communication terminal compares a phone number according to call status (where the call status refers to whether the call is an incoming or outgoing call) with phone numbers stored in the phone directory. If a phone number which is identical to the phone number according to call status exists in the phone directory, a corresponding name of the party with which the communication was established (e.g., the called or calling party). and a corresponding icon for distinguishing among the office phone number, the home phone number, and the cellular phone number are shown on the latest communication record image. If there the outgoing phone number or the incoming phone number is not registered in the phone directory, the outgoing phone number or the incoming phone number is expressed only as figures 130 on the latest communication record image.

However, conventional mobile communication terminals display only one phone number icon corresponding to a single name of a party with which an incoming or outgoing call was established as shown in FIG. 1. For example, a case in which an office phone number and a cellular phone number are registered under an identifier such as of “Daddy” will be described. If a user calls the cellular phone number corresponding to the identifier “Daddy” (i.e., Daddy's cellular phone number), an icon representing an outgoing call and a cellular-phone-shaped icon representing the cellular phone number as indicated by reference numeral 150 are displayed in FIG. 1.

If the user calls Daddy's office phone number, a building-shaped icon representing the office phone number is displayed as indicated by reference numeral 140. In this state, the user then calls Daddy's cellular phone number by manually entering Daddy's cellular phone number. At this time, if the user wishes to call Daddy's office phone number after calling Daddy's cellular phone number, but cannot remember Daddy's office phone number, the user must search the phone directory to find Daddy's office phone number in order to originate a call to Daddy's office phone number.

Thus, the conventional mobile communication terminal displays only a name of a party with which an incoming or outgoing call was established and only single phone number corresponding to the party on the latest communication record image because the conventional mobile communication terminal partially interworks the call history recording function with the phone directory managing function.

As described above, conventionally, since only a single phone number icon is displayed with respect to a single name on the latest communication record image, a user must search a phone directory if the user intends to select another phone number from among several phone numbers registered with respect to one name.

### SUMMARY OF THE INVENTION

Accordingly, the present invention has been made to solve the above-mentioned problems occurring in the prior art, and an object of the present invention is to provide an apparatus and a method for originating a call using the latest communication records in a mobile communication terminal, which enable a user to select a desired phone number to be originated (i.e., called) without an additional search of a phone directory by displaying the latest communication records generated by interworking a call history recording function with a phone directory managing function in the mobile communication terminal.

To accomplish the above objects, there is provided an apparatus for originating a call using latest communication records in a mobile communication terminal, the apparatus including a memory unit for storing call history information and phone directory information and storing latest communication records, the call history information being generated according to call status (i.e., whether a call is an outgoing call on an incoming call), the phone directory information being input by a user, the latest communication records being updated according to the call status, and a control unit for displaying the latest communication records by interworking the call history information generated according to the call status with the phone directory information, receiving one phone number selected from at least one phone number for a target for communication based on the displayed latest communication records, and making communication using the received phone number.

According to another aspect of the present invention, there is provided a method for originating a call using latest communication records in a mobile communication terminal, the method including the steps of displaying a list of the latest communication records according to call status if there is a request for displaying the latest communication records, determining if information regarding communication means for the target is selected, if a target for communication is selected in the list, and performing call connection in the communication means if the information regarding the communication means is selected as the determination result.

### BRIEF DESCRIPTION OF THE DRAWINGS

The above and other objects, features and advantages of the present invention will be more apparent from the following detailed description taken in conjunction with the accompanying drawings, in which:

FIG. 1 is a screen shot illustrating a conventional list of latest communication records by way of example;

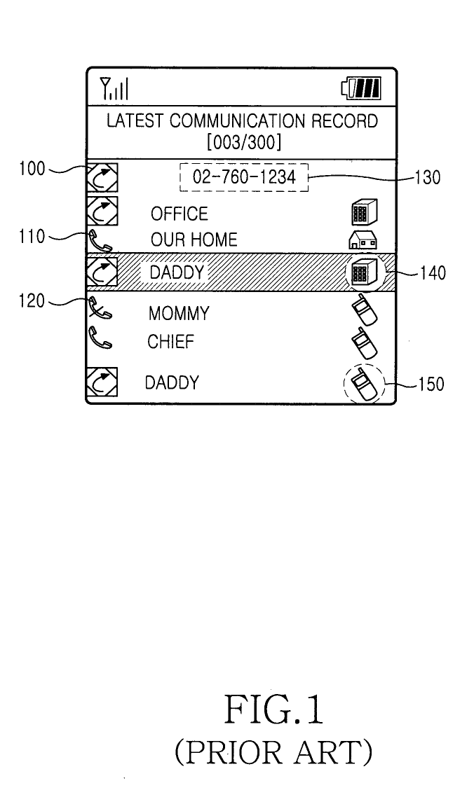

FIG. 2 is a schematic block diagram illustrating an internal structure of a mobile communication terminal for performing a function of calling an outgoing phone number based on the latest communication records according to an embodiment of the present invention;

FIG. 3 is a flowchart illustrating a procedure of generating the latest communication records based on a phone directory according to an embodiment of the present invention;

FIG. 4 is a screen shot illustrating an image of the latest communication records enabling selection of a phone number to be originated according to an embodiment of the present invention; and

FIGS. 5A to 5B are views illustrating an image displaying call history information enabling selection of a phone number to be originated according to another embodiment of the present invention.

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals even though they are shown in different drawings.

The present invention is realized in such a manner that a function enabling a user to originate a call with a desired type of a phone number based on the latest communication records is provided. To this end, the present invention provides for the display of at least one phone number which corresponds to a single name on a latest communication record image displayed on a display unit of a mobile communication terminal. A type of the phone number can be classified into an office phone number, a home phone number, a cellular phone number, a fax number, an emergency contact number, etc., and each of these phone numbers may be expressed as an icon enabling the easy recognition of a corresponding phone number.

In order to display at least one phone number icon corresponding to a single name as described above, the mobile communication terminal must search the phone directory for a phone number input when an outgoing call is made or an incoming call is received so as to be able to determine if a phone number identical to the input phone number exists. If an identical phone number exists, the mobile communication terminal must determine if there are other phone numbers stored with respect to the name corresponding to the identical phone number. If there are a plurality of phone numbers corresponding to the single name stored in the plurality of phone directory, the phone numbers corresponding to the name are displayed in iconic form (or otherwise identified using iconic representation) on the latest communication record image, so as to inform the user that there are a plurality of phone numbers corresponding to the name. A user then selects a desired icon the latest communication record image showing a plurality of phone number icons corresponding to the name without searching for a phone number, thereby enabling the origination of a call.

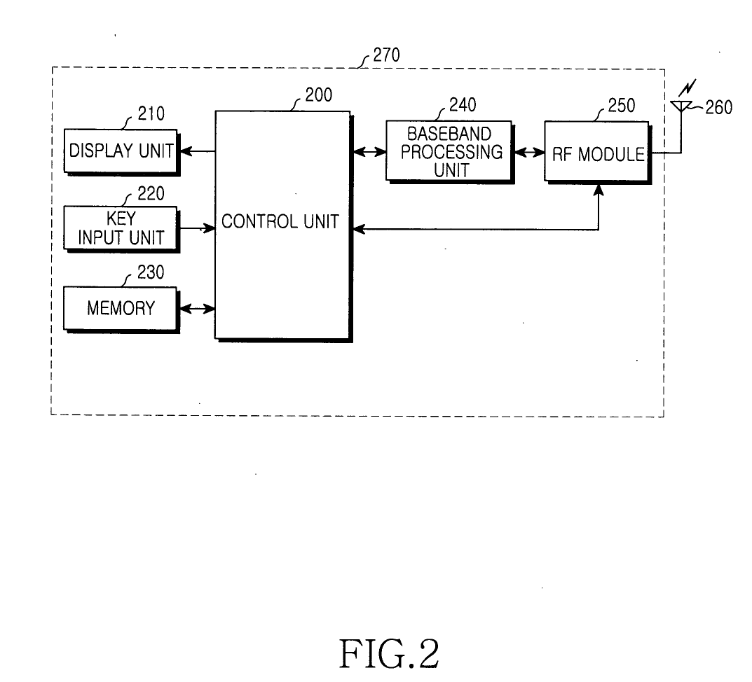

Hereinafter, a function of calling a connection phone number realized in the mobile communication terminal according to an embodiment of the present invention will be described with reference to FIG. 2.

A block diagram illustrating an internal structure of a mobile communication terminal for performing a function of calling an outgoing phone number based on the latest communication records, according to an embodiment of the present invention, is shown in FIG. 2.

A control unit 200 performs an overall control operation of the mobile communication terminal including controlling wireless communication and data processing for the mobile communication terminal. As described below, according to one embodiment of the present invention, the control unit 200 generates new latest communication records such that call history information generated according to the transmission or the reception of communication signals may be interworked with information in a phone directory previously input by a user, and then utilizes the latest communication records, thereby enabling selective call origination without searching the phone directory.

The control unit 200 controls each component of the mobile terminal such that call history information may be managed as a single integrated phone number through the latest communication record image through interworking with information in a phone directory of the mobile communication terminal. Herein, the call history information, which is information generated according to call status, includes one of call connection start time, call connection end time, unanswered call records (e.g., missed calls), an incoming or outgoing callnumber, and information in a phone directory according to the incoming or outgoing call number.

A display unit 210 receives and displays display data corresponding to key input data input from a key input unit 220 or displays an operation state and of information regarding the mobile communication terminal 270 under the control of the control unit 200. In addition, when a function desired by a user is set or operated, the display unit 210 visually shows the set state or an operation state under the control of the control unit 210. In particular, the display unit 210 shows an image of the latest communication records interworked with a function relating to the phone directory according to one embodiment of the present invention.

The key input unit 220 includes various types of keys including numeral keys and provides the control unit 200 with key input data which is input by a user. In other words, the key input unit 220 outputs original key input data according to input of the keys. The key input data output from the key input unit 220 are applied to the control unit 200. The control unit 200 detects the type of a key corresponding to the key input data and performs a corresponding operation according to the detection result. In addition, a plurality of phone number icons corresponding to a single name are displayed on the latest communication record image. A user can select a desired name for call origination using up and down shift keys (not shown), and then select a phone number icon corresponding to the name by using right and left shift keys (not shown). Accordingly, the key input unit 220 determines if a key input from a user on the latest communication record image is an up shift key, a down shift key, a right shift key, or a left shift key and provides the control unit 200 with a result according to corresponding key input. As described above, the key input unit 220 includes direction keys in such a manner that one of one or more phone number icons displayed for a target for communication can be selected.

In addition, a memory unit 230 connected to the control unit 200 can include a read only memory (ROM), a random access memory (RAM), and a voice memory for storing a plurality of programs and information required when operation of the mobile communication terminal 100 is controlled. In addition, according to one embodiment of the present invention, the latest communication record is continuously updated and stored in the memory unit 230 of the mobile communication terminal depending on call history information and information in a phone directory under the control of the control unit 200.

An RF module 250 for transmitting and/or receiving an RF signal to and/or from a base station (not shown) through an antenna (ANT) 260 converts the received RF signal into an intermediate frequency (IF) signal to be output to a baseband processing unit 240. The RF module 250 converts an IF signal input from the baseband processing unit 240 into an RF signal to be transmitted. Herein, the baseband processing unit 240 refers to baseband analog Application Specific Integrated Circuit (BAA) providing an interface between the control unit 200 and the RF module 250. The baseband processing unit 240 converts a baseband digital signal applied from the control unit 200 into an analog IF signal to be applied to the RF module 250 and converts an analog IF signal applied to the RF module 250 into a baseband digital signal to be applied to the control unit 200.

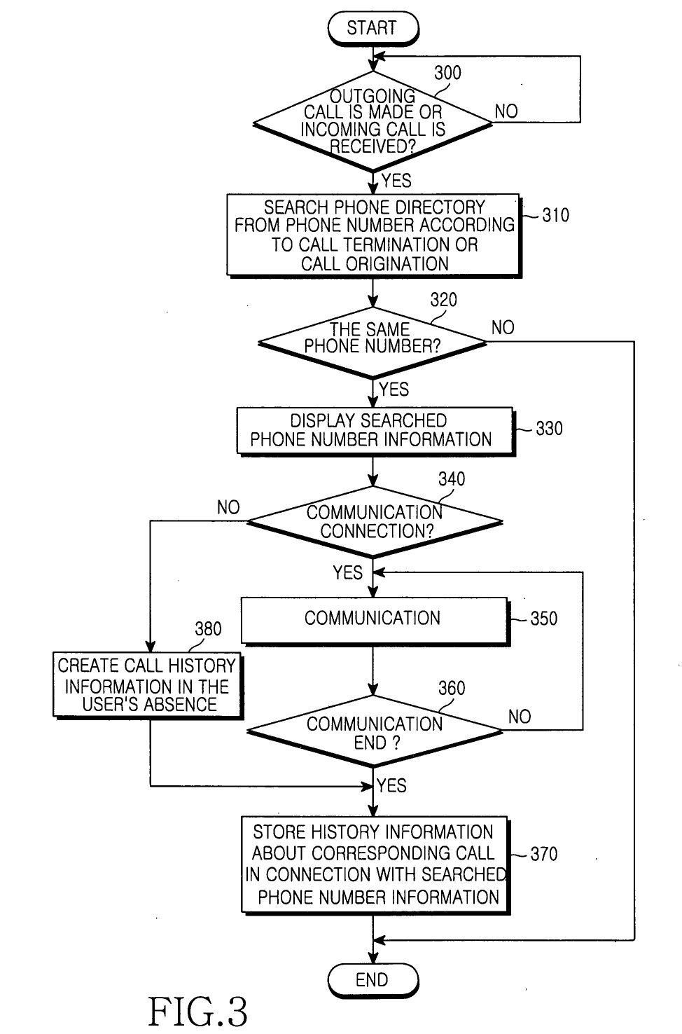

Hereinafter, the operation of the control unit 200 will be described in detail with reference to FIG. 3.

A flowchart illustrating a procedure of generating the latest communication records based on a phone directory according to an embodiment of the present invention is shown in FIG. 3.

The control unit 200 determines if an outgoing call is made or an incoming call is received in step 300. If it is determined that an outgoing call is made or an incoming call is received, the control unit 200 searches a phone directory in step 310 determine, if there is a phone number accords with the number of the outgoing or incoming call in step 320. In step 320, based on the determination in step 300, if there a phone number which accords with the number of the outgoing or incoming call is not registered in the phone directory, the control unit 200 ends the procedure and the number of the outgoing or incoming call is displayed using numeric form.

Alternatively, in step 320, if the phone number in accord with the number of the incoming or outgoing call is found (in other words, the corresponding number is registered) in the phone directory, the control unit 200 displays information regarding the found phone number in step 330. For example, when an incoming call is received, information regarding a person who originated the call (i.e., the name of the person and the phone number of the person) is displayed on a screen of a mobile communication terminal, and a user of the mobile communication terminal can recognize who is calling based on this information. In addition, when an outgoing call is originated, that is, when a key for communication (e.g., a send key) is pressed in the state of the input of the phone number according to call origination, the mobile communication terminal displays an image including the name and the phone number of the called party. The displayed information is searched correspondingly to the input phone number.

Thereafter, the control unit 200 determines if call connection is achieved in step 340. If the call connection is achieved, the control unit 200 starts the communication in step 350. In step 360, the control unit 200 determines if a key for ending communication is pressed during the communication and if the communication has ended, the control unit 200 stores history information regarding the call corresponding to the with searched phone directory information in step 370, thereby updating the latest communication records.

If the call connection is not achieved in step 340, the control unit 200 generates history information regarding a call received in user's absence (i.e., a missed call) or an originated (outgoing) call which reports that call connection is not achieved (e.g. an unanswered call) in step 380.

Thereafter, in step 370, the control unit 200 stores the history information regarding a call received in user's absence or an originated call (e.g., a missed call or an unanswered call, respectively) in connection with information regarding the searched phone number, thereby updating the latest communication record.

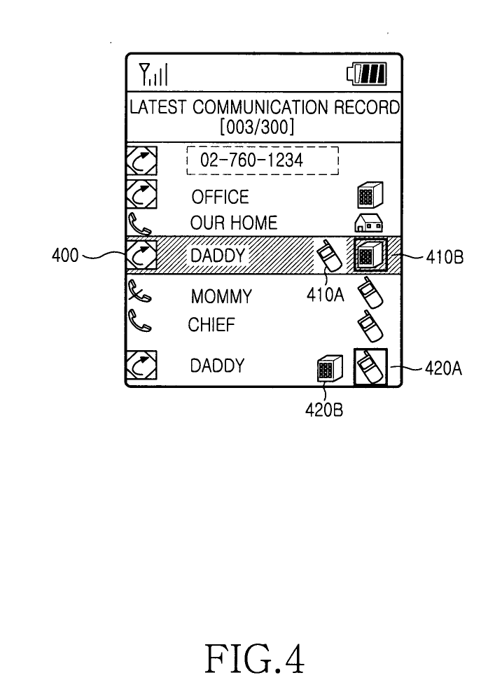

Herein, the call history information denotes information is generated according to call status (i.e., whether the call is an outgoing or an incoming call). The call history information is interworked with the phone directory, thereby generating the latest communication records according to an embodiment of the present invention as shown in FIG. 4.

As described above, the latest communication record image according to the present invention may display an icon corresponding to an input phone number according to call status and a name corresponding to the input phone number. In addition, if there are a plurality of phone numbers stored which correspond to the same name, in addition to the input phone number, all the phone numbers which correspond to the same name the may each be displayed using a different icon.

Hereinafter, a method for originating a call in a mobile communication terminal according to the present invention based on the latest communication records generated through the procedure described above will be described in detail with reference to FIG. 4.

A screenshot illustrating a procedure of generating the latest communication records enabling selection of a phone number to be originated according to an embodiment of the present invention is shown in FIG. 4. If a user's request for the display of the latest communication records is input into the control unit 200, the control unit 200 displays a list of the latest communication records in which one or more different phone numbers are displayed corresponding to a phone number according to call status.

In the method for originating a call according to the present invention, in order to call the other party (after a previous communication with the user of the mobile communication terminal has ended) using a different communication type than was used in the previous communication, a key input for switching into the latest communication record image is received from a user, the name of a party which received a corresponding outgoing call (i.e., the called party) 400 is selected by means of up and down shift keys (not shown) and then one of icons for numbers of phones having different types 410A and 410B (e.g., a cellular phone icon, an office icon, respectively, etc.) is selected by means of left and right shift keys (not shown), so that the call can be originated.

Hereinafter, a case in which a user calls a cellular phone number corresponding to the label “Daddy” and then calls Daddy's office phone number will be described by way of example. Herein, it is assumed that two phone numbers including the cellular phone number and the office phone number are stored in a phone directory corresponding to the label Daddy. When a user originates a call to the cellular phone number, a cellular phone icon is prominently displayed as indicated by reference numeral 420A in FIG. 4. However, when phone numbers are stored corresponding to two different phone number types (e.g., a cellular phone number type and an office phone number type) corresponding to the label Daddy, the latest communication record image further displays an office icon informing that there is a phone number having a different type (i.e., an office phone number) in addition to the cellular phone icon.

Accordingly, a user can originate a call (i.e., make an outgoing call) by selecting one of two phone number icons (i.e., one of icons 420A and 420B) corresponding to the label Daddy displayed on the latest communication record image. Herein, individual icons which identify a phone number's type are displayed on the latest communication record image are expressed as icons representing corresponding phone numbers such that a user may easily select a particular type of phone number from one or more phone number types corresponding to a single name and establish a communication with the selected phone number. Hereinafter, a procedure for originating a call, through which a user can selectively originate a call based on the latest communication record image expressed as described above, will be described in detail. First, the user places a cursor on a target (e.g., on the Daddy label) for communication by using direction buttons included in the mobile communication terminal (e.g., using the up and/or down shift keys) as shown by reference numeral 400 in the latest communication records and then selects a cellular phone icon or an office icon corresponding to the target using right and left shift keys, thereby selecting a desired phone number type. Herein, if the right shift key or the left shift key is pressed in the state in which the target for communication is selected, a corresponding icon according to the pressing of the right key or the left key is accentuated by using a thicker color or through blinking, so as to inform that the corresponding icon is selected.

If the icon representing a phone number type for a target for communication based on the latest communication records is selected as described above, a key for communication (i.e., a send key—not shown) can then be selected, and a phone number corresponding to the selected icon is called.

In addition, when a user originates a call by selecting a cellular phone number from among the cellular phone number and an office phone number, the latest communication record image displays a cellular phone icon and an office icon at the same time, and the cellular phone icon is accentuated in order to indicate that the call to the cellular phone number is being originated. In other words, an icon for an originated phone number may be highlighted or otherwise made to stand out, (e.g. by placing a cursor may be placed on the corresponding icon so that a user can immediately determine that this is the selected icon. Accordingly, the user can recognize the originated phone number even when icons representing a variety of phone number types are displayed correspondingly to one name.

The above description deals with a method for originating a call by directly selecting an icon representing a phone number type for a target for communication through the latest communication record image shown in FIG. 4.

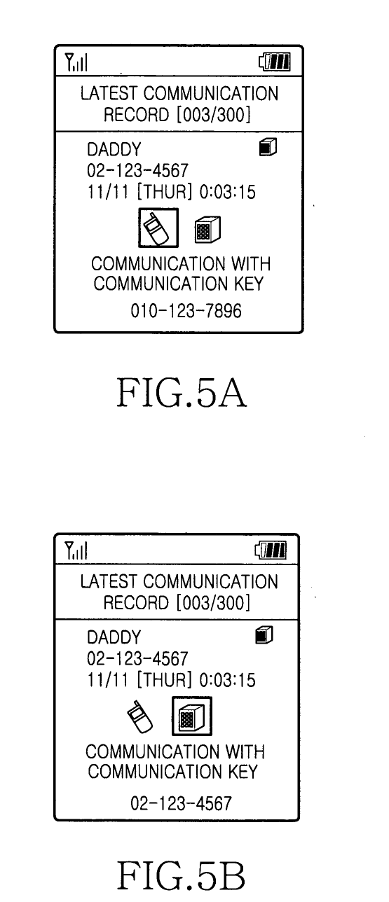

Hereinafter, a method for enabling selective call origination in an image used for confirming call history information according to the latest communication records as well as an image showing the list of the latest communication records will be described according to another embodiment of the present invention. To this end, a latest communication record image enabling the selection of a phone number to be originated according to another embodiment of the present invention is shown in FIG. 5.

The latest communication record image is changed into the image used for detecting call history information though a key input used for detecting communication information corresponding to the Daddy label 400 (see FIG. 4). Then, the call history information image according to the latest communication records displays call history information including the name of a party with which a communication was previously established, called phone numbers, and time spent for communication. Herein, according to another embodiment of the present invention, one of icons shown in FIG 5A may be selected in such a manner that another phone number of the party with which a communication was previously established can be originated.

For example, when a cursor is placed on a cellular phone icon as shown in FIG. 5A, an accentuated cellular phone icon is displayed on the call history information image. Simultaneously, a cellular phone number for the icon is displayed. In addition, when a user selects an office icon instead of the cellular phone icon using direction keys such as right and left shift keys, an accentuated office icon is displayed on the call history information image as shown in FIG. 5B. Simultaneously, a phone number corresponding to the office icon is displayed. Accordingly, a user selects a desired phone number type using an icon, thereby establishing communication using a phone number corresponding to the selected icon.

As described above, when a user wishes to call a party with which a communication was previously established using another phone number of the other party, the user can call the other party by selecting icons (representing various types of phone numbers of the other party) displayed on the latest communication record image without searching the phone numbers in the telephone directory.

As described above, according to the present invention, a typical call history information recording function is interworked with a phone directory function in order to satisfy the special demand of a user as a mobile communication terminal becomes widely used, thereby displaying different phone number types for a target for communication on a latest communication record image and enabling selective call origination based on the latest communication records when the mobile communication terminal originates a call. Accordingly, the user convenience for the call origination is enhanced.

While the invention has been shown and described with certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. An apparatus for originating a call using latest communication records in a mobile communication terminal, the apparatus comprising:
a memory unit for storing call history information and phone directory information and storing latest communication records, the call history information being generated according to call status, the phone directory information being input by a user, and the latest communication records being updated according to the call status, the call status corresponding to at least one of an incoming phone call and outgoing phone call; and
a control unit for displaying the latest communication records by interworking the call history information with the phone directory information, receiving a selected phone chosen from among at least one phone number for a target for communication based on the displayed latest communication records, and establishing a communication using the received phone number.

2. The apparatus as claimed in claim 1, further comprising:
a display unit for displaying in iconic form at least one phone number corresponding to the target for communication; and
a key input unit including direction keys used for selecting the selected phone number.

3. The apparatus as claimed in claim 1, wherein the display unit displays a latest communication record image including icons representing call status and one or more icons representing names according to the call status and phone number types stored corresponding to the call status.

4. The apparatus as claimed in claim 3, wherein the icons representing phone number types includes at least one of an icon representing an office phone number, an icon representing a home phone number and an icon representing a cellular phone number.

5. The apparatus as claimed in claim 3, wherein the at least one icon representing phone number types is previously stored in the phone directory in association with at least one corresponding phone number according to the call status.

6. The apparatus as claimed in claim 1, wherein the control unit displays a list of the latest communication records stored in the memory unit if a user requests the latest communication records and controls at least one icon representing a name of the target for communication and at least one phone number of the target for communication to be displayed on the list of the latest communication records.

7. The apparatus as claimed in claim 6, wherein the control unit determines if there is a key input selecting one of the at least one icon representing different phone number types which corresponds to a target for communication selected from the list of the latest communication records in a state in which the list of the latest communication records is displayed, and, if there is the key input, performing a call connection to a phone number corresponding to the selected icon.

8. A method for originating a call using latest communication records in a mobile communication terminal, the method comprising the steps of:
displaying a list of latest communication records according to call status, if there is a request for displaying the latest communication records, call status corresponding to at least one of an incoming phone call and outgoing phone call;
determining if information corresponding to a communication means to use for a target for communication is selected, if the target for communication is selected in the list of the latest communication records; and
performing a call connection to the target for communication using the information corresponding to a communication means, if the determination finds that the information is selected.

9. The method as claimed in claim 8, further comprising the steps of:
comparing a phone number input according to call status with phone numbers previously stored in a phone directory; and
searching information regarding another stored communication means to use corresponding to the input phone number and generating and storing latest communication records according to the search result, as a result of the comparison, it is determined that there is an identical phone number.

10. The method as claimed in claim 8, wherein the latest communication records are updated by interworking call history information generated according to the at least one of call origination and call termination with previously stored information in the phone directory.

11. The method as claimed in claim 8, wherein the information corresponding to the communication means to use for a target for communication is displayed using at least one icon in the list of the latest communication records.

12. The method as claimed in claim 8, wherein the step of displaying the list of the latest communication records comprises:
selecting, by a user, the target for communication using at least one of an up shift key and a down shift key; and
displaying icons enabling selection of information regarding one or more different communication means to use for the target for communication on one side of an image showing the list of the latest communication records.

13. The method as claimed in claim 12, wherein the icons enabling selection of information regarding one or more different communication means to use for the target for communication represent at least one communication means to use for the target.

14. The method as claimed in claim 13, wherein the icons enabling selection of information regarding one or more different communication means to use for the target for communication include at least of an icon representing an office phone number, an icon representing a home phone number and an icon representing a cellular phone number.

15. The method as claimed in claim 12, wherein the icons enabling selection of information regarding one or more different communication means to use for the target for communication are selected by the user selecting a right shift key or a left shift key from a user.

16. The method as claimed in claim 15, wherein the icons enabling selection of information regarding one or more different communication means to use for the target for communication are accentuated and displayed according to an input of at least one direction key pressed by the user.

17. The method as claimed in claim 16, wherein the icons enabling selection of information regarding one or more different communication means to use for the target for communication are accentuated using at least one of a blinking pattern, a highlighting pattern and an outlining pattern;

18. The method as claimed in claim 13, wherein the icons enabling selection of information regarding one or more different communication means to use for the target for communication are selected by the user selecting a right shift key or a left shift key from a user.

19. The method as claimed in claim 14, wherein the icons enabling selection of information regarding one or more different communication means to use for the target for communication are selected by the user selecting a right shift key or a left shift key from a user.
